(19) United States
(12) Patent Application Publication
(10) Pub. No.: US 2024/0311180 A1
(43) Pub. Date: Sep. 19, 2024

(54) MECHANISM TO MIGRATE THREADS ACROSS OPERATING SYSTEMS IN A DISTRIBUTED MEMORY SYSTEM

(71) Applicant: Samsung Electronics Co., Ltd., Suwon-si (KR)

(72) Inventors: Robert Wisniewski, Ossining, NY (US); Rolf Riesen, Forest Grove, OR (US)

(21) Appl. No.: 18/509,027

(22) Filed: Nov. 14, 2023

Related U.S. Application Data
(60) Provisional application No. 63/452,137, filed on Mar. 14, 2023.

(51) Int. Cl. G06F 9/48

(52) U.S. Cl. CPC G06F 9/4856

(57) ABSTRACT

A method of migrating threads across a first node running a first operating system and a second node running a second operating system that is a different instance than the first operating system. The method includes a task of receiving, by a thread daemon of the first node, a request from a process on the first node to migrate a thread of the process to the second node. The method also includes a task of sending, by the thread daemon of the first node, the request to a thread daemon of the second node, a task of creating, by the thread daemon of the second node, a thread entry in a thread proxy of the second node and a proxy process on the second node, and a task of instantiating the thread within the proxy process.

### CROSS-REFERENCE TO RELATED APPLICATION(S)

The present application claims priority to and the benefit of U.S. Provisional Application No. 63/452,137, filed Mar. 14, 2023, the entire content of which is incorporated herein by reference.

### BACKGROUND

### 1. Field

The present disclosure relates to systems and methods for migrating threads between different operating systems.

### 2. Description of the Related Art

Traditional operating systems, such as Linux, have not been implemented to run across non-coherent nodes. Instead, for n nodes that are in different coherence domains, n copies of the operating system (e.g., Linux) are run. Some hardware provides the capability to have shared memory across nodes, but the memory is not coherent. Thus, while the operating system (e.g., Linux) cannot run across the different nodes, an application could run across the different nodes and threads on each node access the shared memory. Applications could benefit if a thread of the application was able to run on any of the nodes the application is running on, but threads cannot move between different operating systems.

The above information disclosed in this Background section is only for enhancement of understanding of the background of the invention and therefore it may contain information that does not constitute prior art.

### SUMMARY

The present disclosure relates to various embodiments of systems and methods configured to migrate threads across operating systems on different nodes. In one embodiment, the system includes at least a first node of a first computer system and a second node of a second computer system. The first node includes first cores running a first operating system, a first thread proxy, and a first thread daemon, and the second node includes a second cores running a second operating system, a second thread proxy, and a second thread daemon. The first operating system of the first node is a different instance than the second operating system of the second node (e.g., different instances of Linux). The first thread daemon of the first node is configured to send a request to the second thread daemon of the second node in response to a request, from a process on the first node, to create a thread on a core of the second cores of the second node. The second thread daemon on the second node is configured to create a proxy process and instantiate the thread in the proxy process in response to the request.

The memory of the first cores of the first node and the memory of the second cores of the second node is non-coherent.

The second thread daemon may further be configured to create operating system state, e.g., file descriptors that point to the proxy process.

The system may include a /proc/cpuinfo file containing a node identifier field indicating that the first cores are on the first node and the second cores are on the second node.

The second thread daemon may be further configured to send return code to the first thread daemon.

The second thread daemon of the second node may be further configured to send a request to the first thread daemon of the first node in response to a request, from a process on the second node, to create a thread on a core of the first cores of the first node, and the first thread daemon on the first node may be configured to create a proxy process and instantiate the thread in the proxy process in response to the request.

The first thread daemon may be configured to send return code to the second thread daemon.

The first thread daemon may be configured to locally instantiate a thread in response to a request, from the process on the first node, to run the thread on a core of the first cores of the first node.

The second thread daemon may be configured to locally instantiate a thread in response to a request, from a process on the second node, to run the thread on a core of the second cores of the second node.

The first thread daemon may be configured to gather information about the thread in response to the request from the process on the first node.

The present disclosure is also directed to a method of migrating threads across a first node including first cores running a first operating system and a second node including second cores running a second operating system different than the first operating system. In one embodiment, the method includes receiving, by a first thread daemon of the first node, a request from a process on the first node to migrate a thread of the process to a core of the second cores on the second node; sending, by the first thread daemon of the first node, the request to a second thread daemon of the second node; and instantiating, by a second thread proxy on the second node, the thread within a proxy process of the second node.

The method may also include creating, by the second thread daemon of the second node, the proxy process on the second node.

The method may also include referencing a /proc/cpuinfo file containing a node identifier field indicating that the first cores are on the first node and the second cores are on the second node.

The method may also include gathering, by the first thread daemon of the first node, information about the thread prior to the sending of the request.

The method may also include sending, by the second thread proxy on the second node, return code to the first thread daemon on the second node.

The method may also include receiving, by the second thread daemon of the second node, a request from a process on the second node to migrate a thread of the process to a core of the first cores on the first node; sending, by the second thread daemon of the second node, the request to the first thread daemon of the first node; and instantiating, by a first thread proxy on the first node, the thread within a proxy process of the first node.

The method may also include creating, by the first thread daemon of the first node, the proxy process on the first node.

The method may also include sending, by the first thread proxy on the first node, return code to the second thread daemon of the first node.

The first thread daemon may be configured to locally instantiate a thread in response to a request, from the process on the first node, to run the thread on a core of the first cores of the first node.

The second thread daemon may be configured to locally instantiate a thread in response to a request, from a process on the second node, to run the thread on a core of the second cores of the second node.

This summary is provided to introduce a selection of concepts that are further described below in the detailed description. This summary is not intended to identify key or essential features of the claimed subject matter, nor is it intended to be used in limiting the scope of the claimed subject matter. One or more of the described features and/or tasks may be combined with one or more other described features and/or tasks to provide a workable system and/or a workable method.

### BRIEF DESCRIPTION OF THE DRAWINGS

The features and advantages of embodiments of the present disclosure will be better understood by reference to the following detailed description when considered in conjunction with the accompanying figures. In the figures, like reference numerals are used throughout the figures to reference like features and components. The figures are not necessarily drawn to scale.

FIG. 1 is a schematic block diagram of a computer system configured to migrate threads across operating systems in a distributed memory system according to one embodiment of the present disclosure; and

FIG. 2 is a flowchart illustrating tasks of a method of migrating threads across operating systems in a distributed memory system according to one embodiment of the present disclosure.

### DETAILED DESCRIPTION

The present disclosure relates to various embodiments of a method and a computer system configured to migrate threads across different operating systems running on non-coherent cores (i.e., the systems and methods of the present disclosure allow threads to move across different operating systems). In this manner, the systems and methods of the present disclosure enable threads to run across any of the nodes the application is running on.

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

For the purposes of this disclosure, expressions such as “at least one of,” when preceding a list of elements, modify the entire list of elements and do not modify the individual elements of the list. For example, “at least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. Similarly, the expression such as “at least one of A and B” may include A, B, or A and B. As used herein, “or” generally means “and/or,” and the term “and/or” includes any and all combinations of one or more of the associated listed items. For example, the expression such as “A and/or B” may include A, B, or A and B.

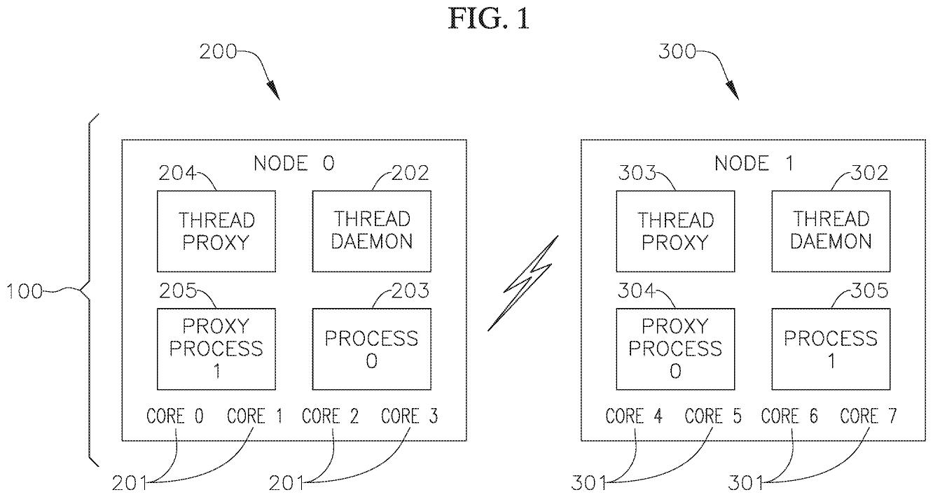

With reference now to FIG. 1, a computer system 100 according to one embodiment of the present disclosure includes a first node 200 (“Node 0”) of a first computer system and a second node 300 (“Node 1”) of a second computer system. The first node 200 includes a plurality of cores 201 (e.g., four cores, “Core 0,” “Core 1,” “Core 2,” and “Core 3”), and the second node 300 includes a plurality of cores 301 (e.g., four cores, “Core 4,” “Core 5,” “Core 6,” and “Core 7”). The memory of cores 201 of the first node 200 is non-coherent with the memory of cores 301 of the second node 300. The first node 200 containing cores 201 runs a first operating system, and the second node 300 containing cores 301 runs a second operating system instance than the first operating system, but the OS same type, e.g., Linux.

Each node in system 100 includes a /proc/cpuinfo file containing a node identifier field, which includes information regarding the locations of the cores 201, 301 (e.g., the /proc/cpuinfo file includes information identifying that the cores “Core 0,” “Core 1,” “Core 2,” and “Core 3” are on the first node 200, and the cores “Core 4,” “Core 5,” “Core 6,” and “Core 7” are on the second node 300). That is, the /proc/cpuinfo file will contain a field indicating which cores are local cores to the given node, and which cores are remote cores.

Additionally, in the illustrated embodiment, the first node 200 includes a thread daemon process 202 configured to receiving an incoming request from a process 203 (“Process 0”) on the first node 200 to migrate a thread of the process 203 (“Process 0”) to one of the cores 301 (e.g., “Core 4,” “Core 5,” “Core 6,” or “Core 7”) of the second node 300. In response to the request, the thread daemon 202 is configured to reference the /proc/cpuinfo file to determine that the requested core 301 (e.g., “Core 4,” “Core 5,” “Core 6,” or “Core 7”) is on the second node 300, gather information about the thread, and send the request to a thread daemon 302 of the second node 300.

The thread daemon 302 of the second node 300 is configured to communicate the request to a thread proxy 303 of the second node 300. In response to the request, the thread proxy 303 of the second node 300 is configured to create a proxy process 304 (“Proxy Process 0”) (if it does not already exist) on the second node 300 that includes pointers for system information (e.g., file descriptors that point to the proxy process 303), and then instantiate the thread within the proxy process 304. As used herein, proxy processes are special processes that know that the “home” of the actual thread is on another node (e.g., Proxy Process 0 on the second node “Node 1” knows that the home of Process 0 is on the first node “Node 0”). In this manner, the system 100 is configured to migrate the thread from the process 203 (“Process 0”) on the first node 200 (“Node 0”) to the proxy process 304 (“Proxy Process 0”) on the second node 300 (“Node 1”).

After the thread has been instantiated on the proxy process 304 (“Proxy Process 0”) on the second node 300 (“Node 1”), the proxy process 304 of the second node 300 is configured to send any return code through the thread proxy 303 to the thread daemon 302 on the second node 300, which then sends that return code to the process 203 (“Process 0”) running on the first node 200 (“Node 0”). In this manner, the system 100 is configured to migrate a thread from the process 203 on the first node 200 to the proxy process 304 on the second node 300 such that the process 203 on the first node 200 receives the output (e.g., return code) from running the thread as if the call had been made locally on the first node 200. That is, even though the thread is run on the proxy process 304 (“Proxy Process 0”) of the second node 300 (“Node 1”), the process 203 (“Process 0”) is configured to receive the output (e.g., return code) from running the thread as if the call had been made locally on the first node 200 (“Node 0”). Requests from the process 203 (“Process 0”) on the first node 200 to run a thread on one of the cores 201 (e.g., “Core 0,” “Core 1,” “Core 2,” or “Core 3”) of the first node 200 will be handled locally on the first node 200.

Similarly, in response to an incoming request from a process 305 (“Process 1”) on the second node 300 to migrate a thread of the process 305 to one of the cores 201 (e.g., “Core 0,” “Core 1,” “Core 2,” or “Core 3”) of the first node 200, the thread daemon 302 is configured to reference the /proc/cpuinfo file to determine that the requested core 201 (e.g., “Core 0,” “Core 1,” “Core 2,” or “Core 3”) is on the first node 200, gather information about the thread, and send the request to the thread daemon 202 of the first node 200.

The thread daemon 202 of the first node 200 is configured to communicate the request to a thread proxy 204 of the first node 200. In response to the request, the thread proxy 204 of the first node 200 is configured to create a proxy process 205 (“Proxy Process 1”) (if it does not already exist) on the first node 200 that includes pointers for system information (e.g., file descriptors that point to the proxy process), and then instantiate the thread within the proxy process 205. In this manner, the system 100 is configured to migrate the thread from the process 305 (“Process 1”) on the second node 300 (“Node 1”) to the proxy process 205 (“Proxy Process 1”) on the first node 200 (“Node 0”).

After the thread has been instantiated on the proxy process 205 (“Proxy Process 1”) on the first node 200 (“Node 0”), the proxy process 205 of the first node 200 is configured to send any return code through the thread proxy 204 to the thread daemon 202 of the first node 200, which then sends that return code to the process 305 (“Process 1”) running on the second node 300 (“Node 1”). In this manner, the system 100 is configured to migrate a thread from the process 305 on the second node 300 to the proxy process 205 on the first node 200 such that the process 305 on the second node 300 receives the output (e.g., return code) from running the thread as if the call had been made locally on the second node 300. That is, even though the thread is run on the proxy process 205 (“Proxy Process 1”) of the first node 200 (“Node 0”), the process 305 (“Process 1”) is configured to receive the output from running the thread as if the call had been made locally on the second node 300 (“Node 1”). Requests from the process 305 (“Process 1”) on the second node 300 to run a thread on one of the cores 301 (e.g., “Core 4,” “Core 5,” “Core 6,” or “Core 7”) of the second node 300 will be handled locally on the second node 300.

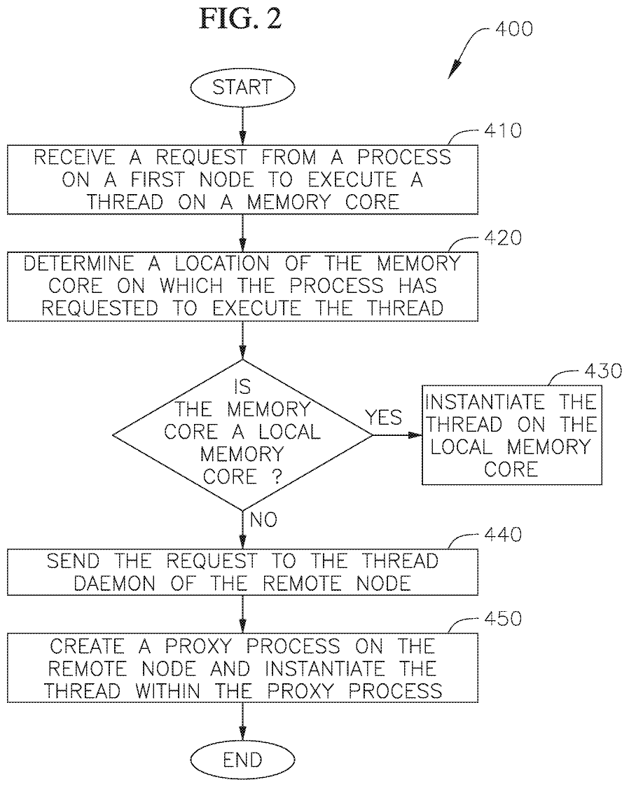

FIG. 2 is a flowchart illustrating tasks of a method 400 of migrating threads across different operating systems running on non-coherent cores of a first node and a second node. In the illustrated embodiment, the method 400 includes a task 410 of receiving, by a thread daemon of the first node, a request from a process on the first node to execute a thread on one of the cores.

In response to the request, the method 400 also includes a task 420 of determining, by the thread daemon, the location of the core on which the process has requested to execute the thread. In one or more embodiments, the task 420 includes the thread daemon referencing a /proc/cpuinfo file containing a node identifier field, which includes information regarding the locations of the cores (e.g., the /proc/cpuinfo file contains a field indicating which cores are local cores and which cores are remote cores).

In response to the core on which the process has requested to execute the thread being a local core, the method 400 includes a task 430 of instantiating the thread on the local core (i.e., in response to the location of the core on which the process has requested to execute the thread not being a remote core, the method 400 includes the task 430 of instantiating the thread on the local core).

In response to the core being a remote core (e.g., the core being on the second node), the method 400 includes a task 440 of sending, by the thread daemon of the first node, the request to the thread daemon of the second node (i.e., the remote node).

In response to the request, the method 400 also includes a task 450 of sending the request from the thread daemon to a thread proxy of the second node, and the thread proxy of the second node creating a proxy process (if it does not already exist) on the second node that includes pointers for system information (e.g., file descriptors that point to the proxy process), and instantiating the thread within the proxy process.

After the task 450 of instantiating the thread on the proxy process on the second node, the method 400 includes a task 460 of sending, by the thread proxy on the second node, any return code to the thread daemon on the second node, and sending, by the thread daemon of the second node, the return code to the process running on the first node. In this manner, the method 400 is configured to migrate a thread from a process on the first node to a proxy process on the second node such that the process on the first node receives the output from running the thread as if the call had been made locally on the first node.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims.

What is claimed is:

1. A system comprising:
at least a first node of a first computer system and a second node of a second computer system, the first node comprising a first plurality of cores running a first operating system, a first thread proxy, and a first thread daemon, the second node comprising a second plurality of cores running a second operating system, a second thread proxy, and a second thread daemon,
wherein the first operating system of the first node is a different instance than the second operating system of the second node,
wherein the first thread daemon of the first node is configured to send a request to the second thread daemon of the second node in response to a request, from a process on the first node, to create a thread on a core of the second plurality of cores of the second node,
wherein the second thread daemon on the second node is configured to create a proxy process and instantiate the thread in the proxy process in response to the request.

2. The system of claim 1, wherein the second thread daemon is further configured to create system information that points to the proxy process.

3. The system of claim 1, wherein the system comprises a /proc/cpuinfo file containing a node identifier field indicating that the first plurality of cores is on the first node and the second plurality of cores is on the second node.

4. The system of claim 1, wherein the second thread daemon is further configured to send return code to the first thread daemon.

5. The system of claim 1, wherein the second thread daemon of the second node is further configured to send a request to the first thread daemon of the first node in response to a request, from a process on the second node, to create a thread on a core of the first plurality of cores of the first node, and wherein the first thread daemon on the first node is configured to create a proxy process and instantiate the thread in the proxy process in response to the request.

6. The system of claim 5, wherein the first thread daemon is configured to send return code to the second thread daemon.

7. The system of claim 1, wherein the first thread daemon is configured to locally instantiate a thread in response to a request, from the process on the first node, to run the thread on a core of the first plurality of cores of the first node.

8. The system of claim 1, wherein the second thread daemon is configured to locally instantiate a thread in response to a request, from a process on the second node, to run the thread on a core of the second plurality of cores of the second node.

9. The system of claim 1, wherein the first thread daemon is configured to gather information about the thread in response to the request from the process on the first node.

10. A method of migrating threads across a first node comprising a first plurality of cores running a first operating system and a second node comprising a second plurality of cores running a second operating system that is a different instance than the first operating system, the method comprising:
receiving, by a first thread daemon of the first node, a request from a process on the first node to migrate a thread of the process to a core of the second plurality of cores on the second node;
sending, by the first thread daemon of the first node, the request to a second thread daemon of the second node; and
instantiating, by a second thread proxy on the second node, the thread within a proxy process of the second node.

11. The method of claim 10, further comprising creating, by the second thread daemon of the second node, the proxy process on the second node.

12. The method of claim 10, further comprising referencing a /proc/cpuinfo file containing a node identifier field indicating that the first plurality of cores is on the first node and the second plurality of cores is on the second node.

13. The method of claim 10, further comprising gathering, by the first thread daemon of the first node, information about the thread prior to the sending of the request.

14. The method of claim 10, further comprising sending, by the second thread proxy on the second node, return code to the first thread daemon on the second node.

15. The method of claim 10, further comprising:
receiving, by the second thread daemon of the second node, a request from a process on the second node to migrate a thread of the process to a core of the first plurality of cores on the first node;
sending, by the second thread daemon of the second node, the request to the first thread daemon of the first node; and
instantiating, by a first thread proxy on the first node, the thread within a proxy process of the first node.

16. The method of claim 15, further comprising creating, by the first thread daemon of the first node, the proxy process on the first node.

17. The method of claim 15, further comprising sending, by the first thread proxy on the first node, return code to the second thread daemon of the first node.

18. The method of claim 10, wherein the first thread daemon is configured to locally instantiate a thread in response to a request, from the process on the first node, to run the thread on a core of the first plurality of cores of the first node.

19. The method of claim 10, wherein the second thread daemon is configured to locally instantiate a thread in response to a request, from a process on the second node, to run the thread on a core of the second plurality of cores of the second node.
